(19) United States
(12) Patent Application Publication
(10) Pub. No.: US 2006/0042891 A1
(43) Pub. Date: Mar. 2, 2006

(54) Wheelchair with hands-free control

(76) Inventors: Eric W. Larson, Pecatonica, IL (US); Fredric James Biddle, Champaign, IL (US); Austin W. Cliffe, DeKalb, IL (US); Ben Chengyuan Shao, Westmont, IL (US)

Correspondence Address: KRIEG DEVAULT LLP, ONE INDIANA SQUARE, SUITE 2800, INDIANAPOLIS, IN, 46204-2079, US

(21) Appl. No.: 11/213,333

(22) Filed: Aug. 26, 2005

Related U.S. Application Data
(60) Provisional application No. 60/604,859, filed on Aug. 27, 2004.

(51) Int. Cl. F16D 65/14

(52) U.S. Cl. 188/109

(57) ABSTRACT

One embodiment of the present invention includes a technique to manually propel movement of a wheelchair in a first direction while being carried by the wheelchair. This wheelchair includes a first wheel with a first brake and a second wheel with a second brake. While participating in a sports activity with one or more hands during this movement, steering the wheelchair in a second direction by hands-free activation of the first brake and in a third direction by hands-free activation of the second brake; and stopping the movement of the wheelchair by hands-free activation of the first brake and the second brake.

### CROSS-REFERENCE TO RELATED APPLICATIONS

The present application claims the benefit of U.S. Provisional Patent Application No. 60/604,859 filed on 27 Aug. 2004, which is hereby incorporated by reference in its entirety.

### BACKGROUND

The present invention relates to wheelchairs, and more particularly, but not exclusively, relates to providing a degree of hands-free control and operation of a wheelchair particularly suited to wheelchair-based sports.

There is a constant demand for more maneuverable/controllable wheelchairs for handicapped individuals. This need is especially prominent for wheelchair-based sporting events such as wheelchair basketball. In this kind of activity, there is a need for a participant to use their hands not only to control a ball, but also to control position and movement of their wheelchair. Indeed, for wheelchair basketball in particular, the wheelchair sometimes can become uncontrollable when a player has direct hand contact with the ball. Accordingly, a need persists for further contributions in this arena.

### SUMMARY

One embodiment of the present invention is a unique wheelchair. Other embodiments include unique methods, devices, and apparatus to provide a degree of hands-free control of a wheelchair. These and further embodiments, forms, features, objects, advantages, benefits, and aspects of the present invention shall become apparent from the detailed description and drawings provided herewith.

### BRIEF DESCRIPTION OF THE DRAWING

FIG. 1 is a front view of a wheelchair of one embodiment of the present invention.

FIG. 2 is a top view of the wheelchair of FIG. 1.

FIG. 3 is a side view of the wheelchair of FIG. 1 with the other side being generally a mirror image thereof.

FIGS. 4A-4C are partial, cut away diagrammatic views of the wheelchair of FIG. 1 illustrating certain operational characteristics.

FIG. 4D is a diagrammatic view of a wheelchair user depicting various positions corresponding to the configurations of FIGS. 4A-4C.

FIGS. 4E-4G are front views of the wheelchair of FIG. 1 in the configurations corresponding to those shown in FIGS. 4A-4C and wheelchair user positions shown in FIG. 4D.

FIGS. 5 and 6 are partial, diagrammatic views of a wheelchair of another embodiment of the present invention that comparatively illustrates several different hands-free operations thereof.

FIGS. 7 and 8 are views of still another embodiment of a wheelchair of the present invention.

FIG. 9 is a rear view of a wheelchair of yet another embodiment of the present invention.

FIG. 10 is a diagrammatic view of a wheelchair of an additional embodiment of a hands-free wheelchair control arrangement.

FIGS. 11 and 12 are diagrammatic views of different embodiments of hands-free control suits applicable to wheelchairs.

FIG. 13 is a view of a hands-free control of a further embodiment applicable to wheelchairs.

### DESCRIPTION OF SELECTED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Among the embodiments of the present application is a manually powered wheelchair with one or more hands-free controls to steer and/or slow forward movement. In one form, this wheelchair is particularly suited to sports activities, including but not limited to, wheelchair basketball. In other forms, this wheelchair arrangement is particularly suited to situations where the wheelchair user desires to perform tasks by hand concurrent with steering and/or braking the wheelchair.

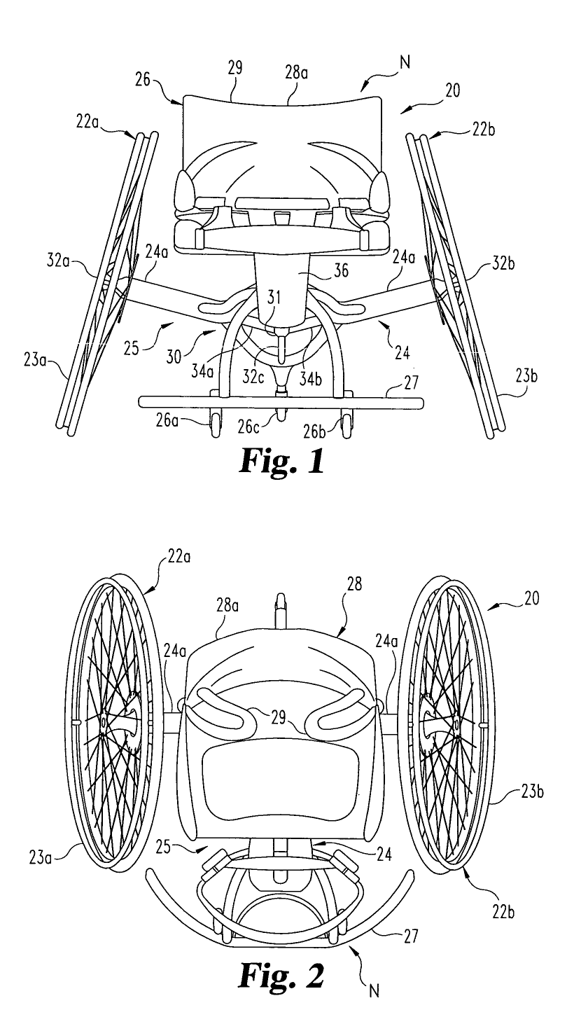

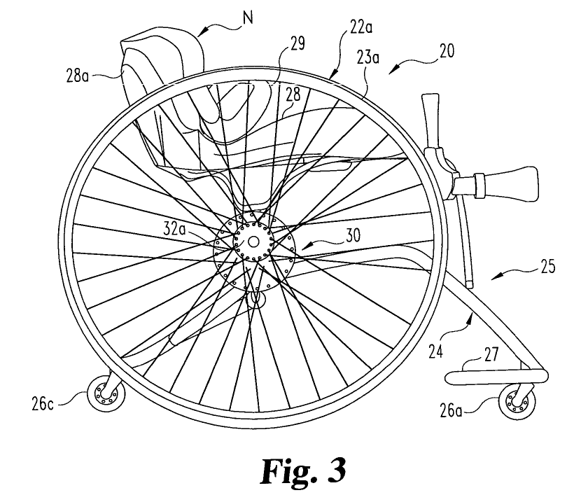

Another embodiment of the present application is illustrated in FIGS. 1-3 as wheelchair 20. FIG. 1 provides a front view, while FIGS. 2 and 3 provide top and side views, respectively, of wheelchair 20. Wheelchair 20 includes manually powered main wheels 22a and 22b, each with a corresponding hand grip 23a and 23b. Wheels 22a and 22b each further include a hub with radiating spokes connected to a rim, and a tire mounted on the rim. Wheelchair 20 further includes frame 25 with support structure 24. Support structure 24 includes fixed axle tree 24a that is journaled to wheels 22a and 22b by appropriate bearings. Wheelchair 20 also includes secondary wheels 26a, 26b, and 26c coupled to frame 25 in a standard manner, and footrest 27 connected to frame 25. Wheelchair 20 has seat 28 with back 28a and user-securing belts 29. Seat 28 is pivotably coupled to support structure 24 by control mechanism 30. Control mechanism 30 includes universal joint 31 that couples seat 28 to support structure 24 to pivot with at least two limited degrees of rotational freedom. Universal joint 31 includes one or more members, such as springs, resilient straps, or the like to maintain and return seat 28 to a neutral position N corresponding to that shown in FIGS. 1-3, and as will be more fully described hereinafter. Control mechanism 30 also includes pivot arm 36 that moves in response to movement of seat 28.

Wheelchair 20 further includes brakes 32a and 32b each operable to selectively slow, stop, and/or prevent rotation of a respective one of wheels 22a and 22b. Brakes 32a and 32b are of a drum type, disc type, or a combination of these. Brakes 32a and 32b are each responsive to force applied to mechanical linkage 34a and 34b, respectively. Mechanical linkage 34c is further interconnected in control mechanism 30 to urge seat 28 back to neutral position N from a different position. Mechanical linkages 34a and 34b are also coupled to pivot arm 36 of control mechanism 30 to respond to at least some movements thereof as explained in connection with certain operations of wheelchair 20.

Referring generally to FIGS. 1-3, the wheelchair user is secured in seat 28 of wheelchair 20 in a standard manner with belts 29. To propel wheelchair 20 forward or backward, the user turns wheels 22a, and/or 22b by hand using the corresponding hand grip 23a and/or 23b. During standard operation, a wheelchair user can steer wheelchair 20 by hand by changing rotational speed of one wheel 22a or 22b in relation to the other wheel 22a or 22b. Alternatively or additionally, the wheelchair user can regulate speed of wheelchair 20 by increasing or decreasing rotation of wheels 22a and 22b by hand via hand grips 23a and 23b.

In addition to steering and braking by hand, Wheelchair 20 provides hands-free control of steering and braking via control mechanism 30. This hands-free control can be desirable with respect to wheelchair sports activities. Alternatively or additionally, the wheelchair user may desire to alternatively or concurrently perform other tasks by hand while using hands-free wheelchair steering and/or speed control.

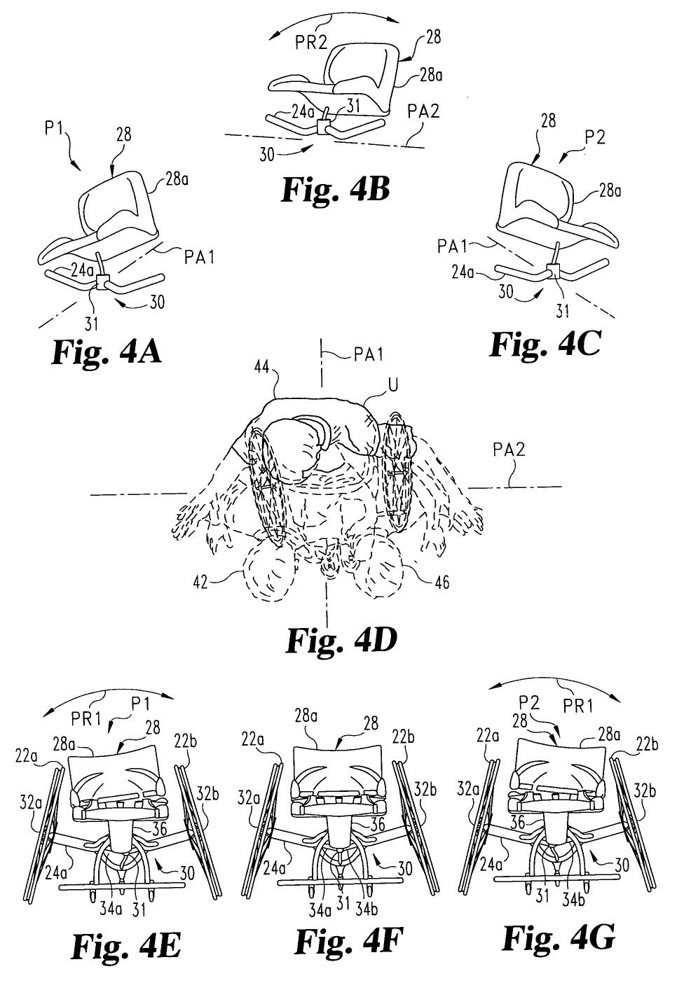

Referring additionally to FIGS. 4A-4G, three alternative positions of wheelchair user U and corresponding mechanical responses/configurations of wheelchair 20 are shown with respect to neutral position N of FIGS. 1-3. In FIGS. 4A-4C, cut away views of different positions of seat 28 are depicted. The corresponding positions of user U in seat 28 are depicted in FIG. 4D, as shown in the alternative at top views of positions 42, 44, and 46. FIGS. 4E-4G provide corresponding front views of wheelchair 20 for each configuration depicted in FIGS. 4A-4C, and the respective user positions 42, 44, and 46.

For the wheelchair configurations of FIGS. 4A and 4E, and corresponding user position 42 of FIG. 4D, seat 28 is moved to position PI by pivoting about pivot axis PA1 from neutral position N. Pivot axis PA1 is illustrated in FIG. 4D. With respect to user U sitting in a face-forward manner in wheelchair 20, seat 28 is tilted to the right in FIGS. 4A and 4E, and user U is leaning or has shifted weight to the right-hand side of seat 28. This shift or leaning by user U causes seat 28 to tilt about axis PA1 as shown in FIGS. 4A and 4E. As seat 28 pivots about axis PA1, pivot arm 36 moves or tilts in the opposite direction away from wheel 22a, which pulls mechanical linkage 34a. In response, brake 32a is activated by mechanical linkage 34a. As a result, only rotation of wheel 22a slows or stops relative to wheel 22b when wheelchair 20 is moving forward (out of the view plane along pivot axis PA1, which is represented by crosshairs in FIG. 4E). As wheel 22a slows down relative to wheel 22b, a hands-free right turn takes place from the perspective of user U. As previously mentioned, mechanism 30 includes one or more springs or other biasing members to urge seat 28 back to a neutral position N under control of user U. When the position of seat 28 returns to neutral position N, brake 32a is deactivated, such that any continued forward movement is generally straight.

Turning to the views of FIGS. 4C and 4G, and position 46 of user U, a hands-free left turn can be executed during forward movement of wheelchair 20 when user U leans or shifts to position 46. This leaning/shifting to the left by user U causes seat 28 to move to position P2 by pivoting about pivot axis PA1 in the opposite direction of that corresponding to position 42 of user U. The resulting tilt repositions pivot arm 36 to pull mechanical linkage 34b. in response, brake 32b is activated, slowing motion of wheel 22b relative to wheel 22a. This action effects a hands-free left turn. As most clearly shown by comparing FIG. 4E and FIG. 4G, seat 28 pivots over a range of different positions designated by pivot range PR1.

FIGS. 4B and 4F correspond to position 44 of user U. In position 44, user U shifts/leans away from neutral position N in a rearward direction against seat back 28a—opposite the direction of forward movement of wheelchair 20. Correspondingly, seat 28 pivots about pivot axis PA2. With this embodiment, axis PA1 and axis PA2 are nonparallel, and generally perpendicular to one another. It should be understood that in other embodiments different relative arrangements between pivot axes can be utilized.

As seat 28 tilts rearward, pivot arm 36 is moved forward, pulling both mechanical linkages 34a and 34b to activate both brakes 32a and 32b at the same time. Accordingly, any rotation of wheels 22a and/or 22b is slowed, stopped, or prevented by hands-free activation. In other words, braking of wheelchair 20 can be effected by pivoting seat 28 to a rearward position.

To release brakes 32a and 32b, seat 28 is returned to neutral position N. It should be noted that various positions about axis PA2 are represented by range PR2 shown in FIG. 4B which can correspond to different degrees of braking.

It should be appreciated that in some alternative embodiments only steering by activation of one brake or another or only braking by activation of both brakes simultaneously is provided. In still other embodiments, the degree of braking can be varied by changing position along range PR1 and/or range PR2. In other embodiments, steering in a given direction and/or braking may be effected by different hands-free positions of user U and/or tilting of seat 28 about one or more differently oriented pivot axes in one or more different ways or directions. Likewise, while a continuous range of variation between turning positions over range PR1 and/or braking positions over range PR2 are provided by wheelchair 20, in other arrangements one or more of these may be configured such that braking and/or turning is effected without a detected degree of variation—resulting in a generally discrete, on/off operation from the perspective of the user. In further embodiments, the type of brake utilized may differ.

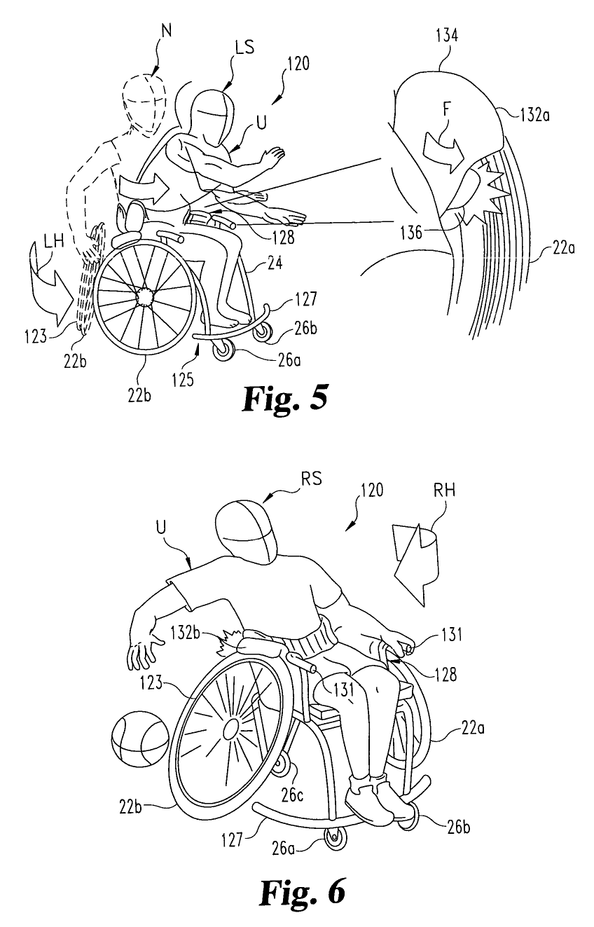

For example, wheelchair 120 of FIGS. 5 and 6 illustrate an alternative embodiment with a scuffer brake type; where like reference numerals refer to like features previously described. Wheelchair 120 includes manually powered main wheels 22a and 22b structured with hand grip 123 for user U to drive/propel by hand. FIG. 5 provides a perspective schematic view of user U in wheelchair 120 shown in two alternative positions, and further includes an enlarged portion 120a to better depict certain aspects of this embodiment. In FIG. 6, user U is depicted in wheelchair 120 as participating in a wheelchair-based basketball activity. Wheelchair 120 further includes frame 125 with support structure 124. Support structure 124 includes an axle tree (not shown) that is journaled to wheels 22a and 22b by appropriate bearings. Wheelchair 120 also includes secondary wheels 26a, 26b, and 26c coupled to frame 125, and footrest 127 connected to frame 125. Wheelchair 120 has seat 128 with a back (not shown), hand-holds 131, and pressure-activated scuffer brakes 132a and 132b. Brakes 132a and 132b are each structured with a user activation member 134 and a scuffer pad 136 to selectively engage a respective one of wheels 22a and 22b as further described hereinafter.

In operation, user U propels wheelchair 120 in the same manner as described for wheelchair 20, and can steer/brake wheelchair 120 by hand in the same manner. In FIG. 5, user U is shown propelling wheelchair 120 while in a neutral position N and further is shown in an alternative position A to be further described as follows. Wheelchair 120 can operate in a hands-free mode, as exemplified by left-shifted position LS of user U. Each brake 132a and 132b is incorporated into wheelchair 120 in a position that normally does not cause contact with a respective wheel 22a and 22b. This position is maintained by one or more springs, elastic straps, or other mechanisms. In one form, member 134 includes a leaf spring connection to wheelchair 120 to implement this feature; however, many other arrangements could alternatively or additionally be utilized. To deviate from this normal position, user U can apply a force F against member 134 as represented by the like-labeled arrow in FIG. 5. More specifically, as user U leans against member 134 of brake 132a, the corresponding scuffer pad 136 is urged into contact with wheel 22a. As a result of this braking contact, any rotation of wheel 22a slows or stops relative to wheel 22b—causing a left-hand turn to take place (from the perspective of user U), as represented by arrow LH in FIG. 5. By discontinuing contact with member 134 of brake 132a, brake 132a is biased to return to the neutral position N, disengaging wheel 22a. A right turn can be executed in a like manner by user U shifting/leaning in an opposite direction as indicated by the right-shifted user position RS in FIG. 6. Accordingly, scuffer pad 136 of brake 132b makes contact with wheel 22b to slow or stop rotation thereof. Arrow RH represents a right hand turn of this type in FIG. 5. By discontinuing contact with brake 132b it returns to the neutral position N. Consequently, wheelchair 120 provides another implementation of hands-free operation.

In other embodiments, it should be appreciated that brake 132a and/or 132b can be activated independently by one or more different movements/positions of user U than those previously described. In still other embodiments, mechanical linkages, pneumatic linkages, and/or hydraulic linkages can be used to activate brakes that are moved in response to movement of user U. In one example, a pivoting seat arrangement is additionally utilized to actuate one or more of brakes 132a and 132b. In another example, seat 128 pivots in a rearward direction to activate both the brakes simultaneously while individual, hands-free activation of each brake 132a and 132b is accomplished by user U leaning to contact member 134 as previously described in connection with FIGS. 5 and 6.

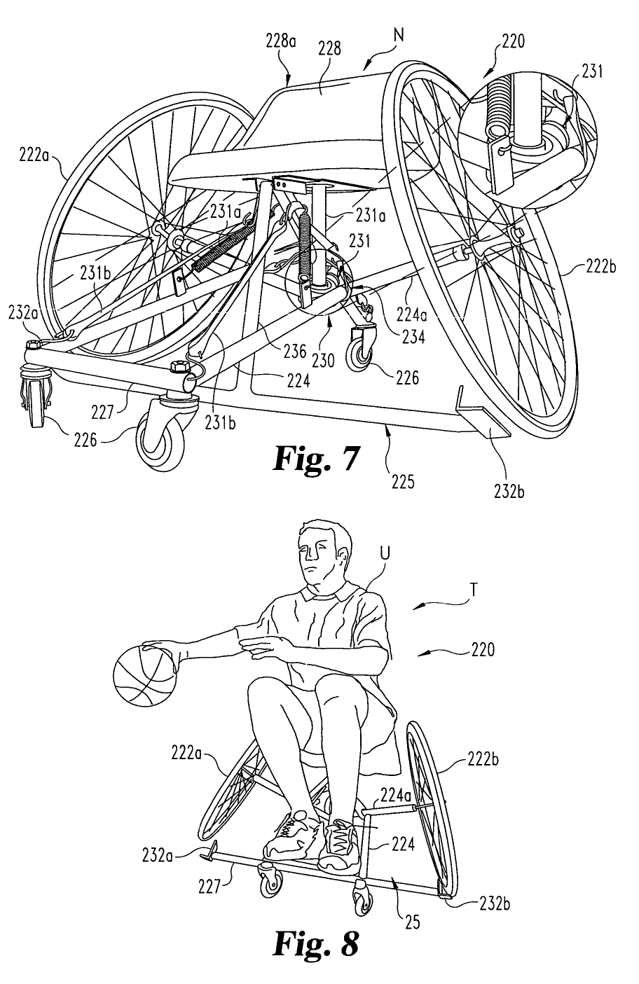

Referring to FIGS. 7 and 8, wheelchair 220 implements yet another example including scuffer-type brakes. In FIGS. 7 and 8, like reference numerals refer to like features previously described. FIGS. 7 and 8 are digital images of a prototype wheelchair of one experimental example of the present invention.

Wheelchair 220 includes manually-powered main wheels 222a and 222b. Wheelchair 220 further includes frame 225 with support structure 224. Support structure 224 includes axle tree 224a that is journaled to wheels 222a and 222b by appropriate bearings. Wheelchair 220 also includes secondary wheels 226 coupled to frame 225 and footrest 227 connected to frame 225.

Wheelchair 220 has seat 228 with back 228a. Seat 228 is pivotally coupled to support structure 224 by control mechanism 230. Control mechanism 230 includes universal joint 231 that couples seat 228 to support structure 224 to pivot with at least two limited degrees of rotational freedom. Universal joint 231 includes one or more resilient members, such as coil springs 231a and/or organic polymer straps 231b to maintain and return seat 228 to neutral position N from a tilted or pivoted position T of seat 228.

Control mechanism 230 includes scuffer brakes 232a and 232b that are each operable to slow or stop rotation of a respective one of wheels 222a and 222b; and corresponding mechanical control linkages. Brakes 232a and 232b are fixed to pivoting arm 236. Arm 236 selectively moves in response to force exerted by a respective one of two mechanical linkages 234. When seat 228 pivots to the right, one such linkage 234 is pulled, which causes brake 232a to engage wheel 222a. As a result, wheel 222a is selectively slowed or stopped relative to wheel 222b when both wheels are rotating—thus causing wheelchair 220 to turn to the right. By pivoting seat 228 to tilt in the opposite direction (to the left), another linkage 234 pulls on arm 236 in the opposite direction to move brake 232b so that it engages wheel 222b. In response, wheel 222b is selectively slowed/stopped relative to wheel 222a when both wheels 222a and 222b are rotating—thus causing wheelchair 220 to turn left. By tilting seat 228 to the rear, both linkages 234 are pulled simultaneously, causing both brakes 232a and 232b to slow/stop wheelchair 220 without changing direction. Consequently, wheelchair 220 has hands-free steering/braking with pivot axes, ranges, and operating positions comparable to those of wheelchair 20—utilizing scuffer brakes instead of drum or disk brakes.

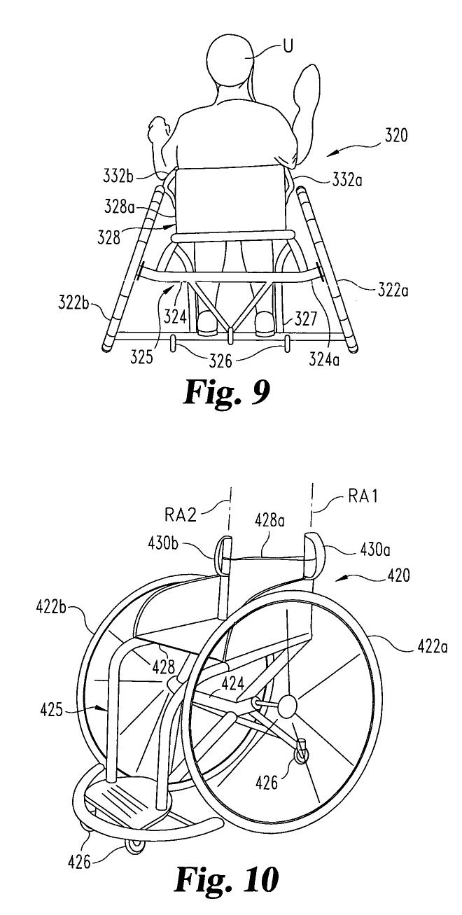

FIG. 9 depicts wheelchair 320 of a further embodiment; where like reference numerals refer to like features. Wheelchair 320 has manually-propelled main wheels 322a and 322b journaled to support structure 324 of frame 325 by axle tree 324a. Footrest 327 and secondary wheels 326 are also coupled to support structure 324. Wheelchair 320 includes seat 328 with back 328a. As depicted in FIG. 9, a rear view of wheelchair 320 is shown with user U facing forward.

Wheelchair 320 further includes brakes 332a and 332b. Brakes 332a and 332b are structured to move in response to a downward pressure or force to correspondingly make contact with a respective one of wheels 322a and 322b. Brake 332a is shown in such a wheel-engaging position obtained by user U applying pressure with an upper arm or upper body portion on the right side. In contrast, brake 332b is not activated, being in a normally unbiased, disengaged position. The depicted activation of brake 332a only results in braking of wheel 322a causing a right-hand turn to result from the perspective of user U, when wheelchair 320 is moving forward with both wheels 322a and 322b rotating. If user U stops applying sufficient force or pressure, brake 332a disengages from wheel 322a, being biased to return to a disengaged position as shown for brake 332b. Brake 332b is structured in a like manner so that it can selectively be used to cause left-hand turns when engaged by a left-hand side upper arm or body portion of user U. Further, hands-free braking without turning can be accomplished by engaging both brakes 332a and 332b at the same time.

FIG. 10 illustrates wheelchair 420 of yet another embodiment of the present invention; where like reference numerals refer to like features previously described. Wheelchair 420 includes manually-propelled main wheels 422a and 422b. Frame 425 of wheelchair 420 includes support structure 424 that is journaled to wheels 422a and 422b by appropriate bearings. Wheelchair 420 further includes secondary wheels 426, and hands-free brake/steering controls 430a and 430b.

Hands-free braking controls 430a, 430b each pivot about a corresponding rotational axis RA1 and RA2. Axes RA1 and RA2 are generally parallel to each other, and extend vertically. Each control 430a and 430b can be independently rotated about its respective axis RA1 and RA2 by application of force or pressure with an elbow or other upper body portion of user U. Each control 430a and 430b is arranged to return to a selected neutral position when such force or pressure is removed. Wheelchair 420 further includes brakes (not shown) each controlled by a respective one of controls 430a and 430b. Specifically, rotation of control 430a about axis RA1 causes one brake to engage wheel 422a while rotating control 430b about axis RA2 causes another brake to engage wheel 422b. By activating only one of these brakes during forward rotating motion of wheels 422a and 422b, only one wheel is slowed or stopped causing a corresponding turn in a left or right direction, respectively. By activating both controls 430a and 430b at the same time while wheelchair 420 is moving, both wheelchair brakes are activated, causing slowing or stopping of wheelchair 420 without turning.

In yet further embodiments, various control suits are utilized to provide for hands-free steering and braking control. In one form, these suits can be arranged to assist in returning a user U to the neutral position from a leaning position, as applicable. For certain sports applications in particular (like wheelchair basketball) such suits can be utilized to “level the playing field” with respect to participants with different levels of disability. For example, a level 1 disabled player would typically need assistance to be righted from a leaning position. Nonetheless, a suit-based control could be utilized in other embodiments independent of such considerations.

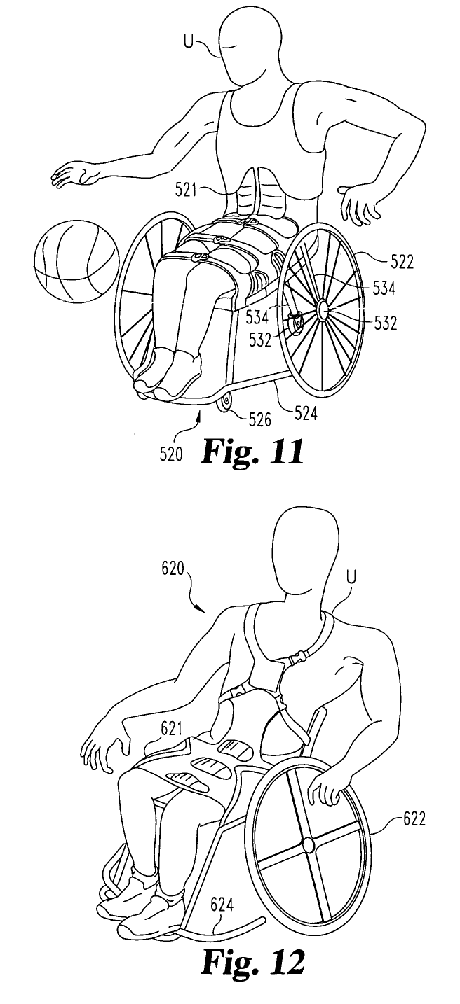

FIG. 11 illustrates one example of wheelchair 520 in which user U wears control suit 521. Wheelchair 520 includes manually-propelled main wheels 522 (only one of which is shown), support structure 524 to which wheels 522 are journaled, and secondary wheels 526 connected to support structure 524. Wheelchair 520 further includes various mechanical, pneumatic, or hydraulic linkages 534 to suit 521 to independently actuate brakes 532 to steer and/or stop wheelchair 520 (only one of which is shown) as described for previous embodiments.

In still a further example, wheelchair 620 of FIG. 12 is shown where like reference numerals refer to like features previously described. User U in wheelchair 620 is wearing control suit 621. Wheelchair 620 further includes manually-powered main wheels 622 (only one of which is shown) journaled to support structure 624. As described in connection with wheelchair 520, control suit 621 is operatively connected by one or more control linkages to left and right wheel brakes (not shown) of wheelchair 620 to provide for selective hands-free steering and/or braking.

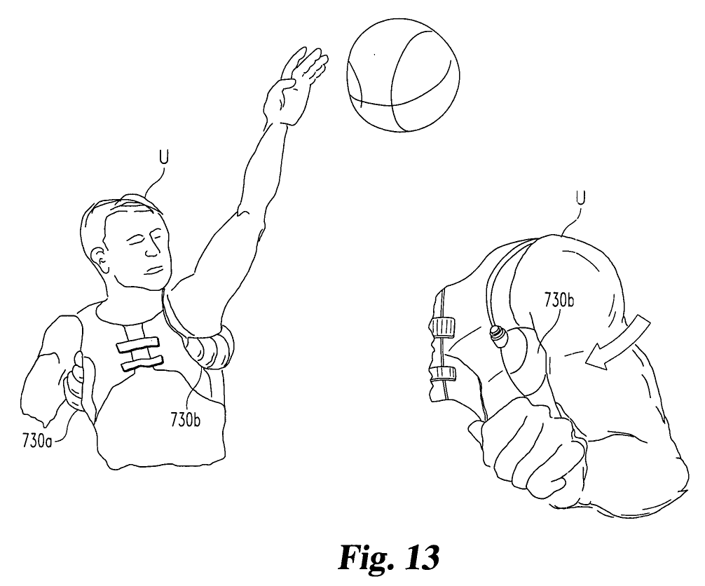

In still a further embodiment, FIG. 13 illustrates hands-free under arm wheelchair controls 730a and 730b as worn by a user U that can be used to independently activate left and right wheel brakes of a manually-powered wheelchair. An enlarged, partial view of the left side of user U with control 730b is also depicted. In yet other embodiments, various features of the embodiments shown in FIGS. 1-13 are combined, interchanged, duplicated, removed, or substituted in a manner as would occur to those skilled in the art to provide one or more hands-free operating modes of a manually powered wheelchair.

Another embodiment of the present invention includes: manually powering forward motion of a wheelchair that includes a first wheel with a first brake and a second wheel with a second brake; leaning a first way in the wheelchair to activate the first brake and turn the wheelchair left; and leaning a second way in the wheelchair to activate the second brake and turn the wheelchair right. Alternatively or additionally, this embodiment can include leaning a third way in the wheelchair to activate both brakes to slow the wheelchair.

Yet another embodiment of the present invention includes a first wheel and a first brake, a second wheel and a second brake, a support structure extending between the wheels that is coupled thereto, and a seat movably coupled to the support structure to pivot over a range relative to the support structure. The first brake responds to pivoting of the seat to a first position along the range to slow rotation of the first wheel when the first wheel is rotating and the second brake responds to pivoting of the seat to a second position along the range to slow rotation of the second wheel when the second wheel is rotating.

A further embodiment is directed to a wheelchair that includes a first wheel and a first brake, a second wheel and a second brake, a frame extending between the wheels that is rotably coupled thereto, and a seat movably coupled to the frame to pivot over a range relative to the frame. The wheelchair can be structured for manual propulsion by a user in the seat. The first and second brakes both respond to pivoting the seat from a first position to a second position along the range by respectively engaging the first and second wheels to slow the wheelchair when in motion with rotation of the first and second wheels. In one optional form, the seat is further operable to pivot over another range to steer the wheelchair. One of the first and second brakes is activated more than the other by pivoting the seat to a first position along this other range to steer the wheelchair in a first direction and another of the first and second brakes is activated more than the other by pivoting the seat to a second position along the range to steer the wheelchair in a second direction.

Still a further embodiment includes: rolling a manually propelled wheelchair that includes a first wheel with a first brake, a second wheel with a second brake, and a pivotably mounted seat; steering the wheelchair right by pivoting the seat in a first direction while rolling;

and steering the wheelchair left by pivoting the seat in a second direction different than the first direction while rolling. Optionally, this embodiment may further include pivoting the seat in a rearward direction relative to forward movement of the wheelchair to activate both the first brake and the second brake to slow the wheelchair.

A further embodiment includes: causing forward movement of a manually propelled wheelchair that includes a first wheel with a first brake, a second wheel with a second brake, and a seat operable to pivot over a range. This seat is coupled to the first brake and the second brake. This embodiment further includes pivoting the seat from a first position to a second position along the range; and activating the first brake and second brake together to stop the forward movement of the wheelchair in response to the pivoting.

A different embodiment includes a wheelchair, comprising: a first wheel and a first brake; a second wheel and a second brake; a support structure extending between the first wheel and the second wheel that is rotatably coupled to the first wheel and the second wheel; a seat movably coupled to the support structure to pivot over a range relative to the support structure; and wherein the wheelchair is structured to be manually propelled by a user from the seat, and the first brake and the second brake both respond to pivoting the seat from a first position to a second position along the range by respectively engaging the first wheel and the second wheel to slow the wheelchair when moving by rotation of the first wheel and the second wheel. Optionally, one form includes means for hands-free steering of the wheelchair. In another optional form of this embodiment, the first range is defined to pivot about a first reference axis, the seat is further operable to pivot over a second range about a second reference axis to steer the wheelchair, one of the first brake and the second brake is activated by pivoting the seat to a first position along the second range, and another of the first brake and the second brake is activated by pivoting the seat to a second position along the second range.

All publications, patent, and patent applications cited in this specification are herein incorporated by reference as if each individual publication, patent, or patent application were specifically and individually indicated to be incorporated by reference and set forth in its entirety herein. Any theory of operation or finding described herein is merely intended to provide a better understanding of the present invention and should not be construed to limit the scope of the present invention as defined by the claims that follow to any stated theory or finding. While the invention has been illustrated and described in detail in the drawings and foregoing description, the same is to be considered as illustrative and not restrictive in character, it being understood that only the preferred embodiment has been shown and described and that all changes, modifications, and equivalents that come within the spirit of the invention as previously described or illustrated heretofore and/or defined by the following claims are desired to be protected.

What is claimed is:

1. A method, comprising:
rolling a manually propelled wheelchair, the wheelchair including a first wheel with a first brake, a second wheel with a second brake, and a pivotably mounted seat;
steering the wheelchair right by pivoting the seat in a first direction during said rolling; and
steering the wheelchair left by pivoting the seat in a second direction different than the first direction during said rolling.

2. The method of claim 1, which includes slowing the wheelchair by pivoting the seat in a rearward direction relative to forward movement of the wheelchair.

3. The method of claim 1, wherein:
said first direction is approximately opposite said second direction;
said pivoting the seat in the first direction slows rotation of the first wheel with the first brake to turn to the right; and
said pivoting the seat in the second direction slows rotation of the second wheel with the second brake to turn to the left.

4. The method of claim 3, which includes pivoting the seat in a rearward direction relative to forward movement of the wheelchair to activate both the first brake and the second brake to slow the wheelchair.

5. The method of claim 4, wherein said pivoting the seat in the first direction and said pivoting the seat in the second direction both occur about a first reference axis and said pivoting the seat in a rearward direction occurs about a second reference axis, the first axis being nonparallel to the second axis.

6. The method of claim 5, wherein the first axis and the second axis are approximately perpendicular to one another.

7. The method of claim 1, wherein the first brake and the second brake are each of a disk brake type or a drum brake type.

8. The method of claim 1, wherein the first brake and the second brake are each of a scuffer brake type.

9. A method, comprising:
manually propelling movement of a wheelchair in a first direction while being carried by the wheelchair, the wheelchair including a first wheel with a first brake and a second wheel with a second brake;
while participating in a sports activity with one or more hands during the movement, steering the wheelchair in a second direction by hands-free activation of the first brake and in a third direction by hands-free activation of the second brake; and
stopping the movement of the wheelchair by hands-free activation of the first brake and the second brake.

10. The method of claim 9, wherein said steering includes leaning left in a seat of the wheelchair to activate the first brake and leaning right in the seat of the wheelchair to activate the second brake.

11. The method of claim 10, wherein:
said stopping includes leaning back in the seat of the wheelchair; and
said leaning right and said leaning left each include pivoting the seat.

12. The method of claim 9, wherein the sports activity is wheelchair basketball.

13. The method of claim 9, wherein the first brake and the second brake are each of a disk type, a drum type, or a scuffer type.

14. The method of claim 9, wherein said steering includes not activating the second brake during the activation of the first brake and not activating the first brake during activation of the second brake.

15. The method of claim 14, wherein said stopping is performed over a time period and includes activating the first brake and the second brake simultaneously for at least a portion of the time period.

16. A wheelchair, comprising:
a first wheel and a first brake;
a second wheel and a second brake;
a support structure extending between the first wheel and the second wheel, the support structure being rotatably coupled to the first wheel and the second wheel;
a seat movably coupled to the support structure to pivot over a first range relative to the support structure; and
wherein the wheelchair is structured to be manually propelled by a user from the seat, the first brake responds to pivoting the seat to a first position along the first range to slow rotation of the first wheel when the first wheel is rotating and the second brake responds to pivoting the seat to a second position along the first range to slow rotation of the second wheel when the second wheel is rotating, the first position along the first range and the second position along the first range being different from one another.

17. The wheelchair of claim 16, wherein the first range is defined to pivot about a first reference axis, the seat is further operable to pivot over a second range about a second axis, the first brake and the second brake are activated to slow the first wheel and the second wheel when the seat is pivoted to a first position along the second range, and the first brake and the second brake are unactivated when the seat is pivoted to a second position along the second range.

18. The wheelchair of claim 16, wherein the first brake and the second brake are each of a disk type, a drum type, or a scuffer type.

19. The wheelchair of claim 16, wherein the first position along the first range and the second position along the first range are generally opposite one another, the first position along the first range corresponds to a first side of the wheelchair, and the second position along the first range corresponds to a second side of the wheelchair, the second side being opposite the first side, and one of the first side and the second side being left of the user in the seat and another of the first side and the second side being right of the user in the seat.

20. The wheelchair of claim 16, further comprising means for activating both the first brake and the second brake to slow the wheelchair when both the first wheel and the second wheel are turning.

21. A method, comprising:
by hand, propelling forward motion of a manually driven wheelchair, the wheelchair including two or more wheels;
during the forward motion, moving a first way in the wheelchair to provide hands-free braking of one of the wheels of the wheelchair; and
during the forward motion, moving a second way in the wheelchair to provide hands-free braking of another of the wheels of the wheelchair.

22. The method of claim 21, wherein said moving the first way includes leaning left and said moving the second way includes leaning right.

23. The method of claim 21, which includes participating in a sports activity during the forward motion.

24. The method of claim 21, wherein said moving the second way includes leaning in a direction approximately opposite the forward motion to slow the wheelchair, and said moving a first way includes pivoting a seat of the wheelchair.

25. The method of claim 21, wherein said moving includes activating the first brake with a suit worn by a user sitting in the wheelchair.
